(19) United States
(12) Patent Application Publication
(10) Pub. No.: US 2009/0083323 A1
(43) Pub. Date: Mar. 26, 2009

(54) Renting or purchasing digital media data selectable by a plurality of methods and delivered to customer by a plurality of delivery methods

(75) Inventors: Timothy J. Elliott, Huntington Beach, CA (US); William Pat Price, Rhome, TX (US)

Correspondence Address: Law Office of Scott C Harris Inc, PO Box 1389, Rancho Santa Fe, CA, 92067, US

(73) Assignee: VIZIO, Irvine, CA (US)

(21) Appl. No.: 11/859,708

(22) Filed: Sep. 21, 2007

(51) Int. Cl. G06F 17/30

(52) U.S. Cl. 707/104.1; 707/E17.001

(57) ABSTRACT

A customer can rent digital content that is encoded onto rewritable media at the time of rental or purchase. The user has the ability to select the digital content, the media that the content is encoded onto, the method of delivery, and the period of the rental if applicable, and options for the cost for the purchase or rental. This system gives the customer control over the complete transaction from first contact with the system to acquisition of the content.

### BACKGROUND

Consumer rental operations such as video rental stores have been in operation for over twenty years. These businesses have also expanded their offerings to include video games and platform specific games for game stations such as Microsoft's X-Box and Sony's Play Station. These rental businesses are limited by the size of their inventory. Stocking in excess of one hundred thousand video titles and thousands of games is out of the question for these traditional consumer outlets. Consumers have always faced the issue of not knowing if a video or a game is in stock until they visit the store.

NetFlix attempted to address this issue by aggregating the inventory of thousands of stores in a centralized operation. NetFlix advertises that they stock over seventy-five thousand titles. Obviously they do not stock the same number of movies for each title. NetFlix allows the consumer to order some number of movies on an internet web site and the movies are mailed to the consumer. The consumer views the movies then mails them back to NetFlix.

NetFlix attempts to manage the issue of the consumer not knowing if a video rental store has a title they wish to view in stock. To accommodate the consumer, NetFlix has to stock an incredible number of DVDs (Digital Versatile Disc). If a new release of a movie is very popular, NetFlix has to make a judgment call as to how many DVDs for that movie it needs to stock. If they stock too few because the movie proves to be more popular than expected, then the consumers choosing that movie have to wait until other NetFlix customers return their copies of the movie or until NetFlix buys more copies.

### BRIEF DESCRIPTION OF THE DRAWINGS

Embodiments of the present invention are illustrated by way of example, and not by way of limitation. The following figures and the descriptions both brief and the detailed descriptions of the invention refer to similar elements and in which:

FIG. 1 is a diagram depicting an embodiment for renting and purchasing digital files including delivery of said files through a plurality of delivery methods.

FIG. 2 is a diagram of an embodiment that transfers customer selected digital files to customer selected media.

FIG. 3 is a diagram of an embodiment that performs customer billing transactions.

FIG. 4 is a diagram of an embodiment that performs the Kiosk processing including transferring customer selected digital files to customer selected media.

### DESCRIPTION OF THE INVENTION

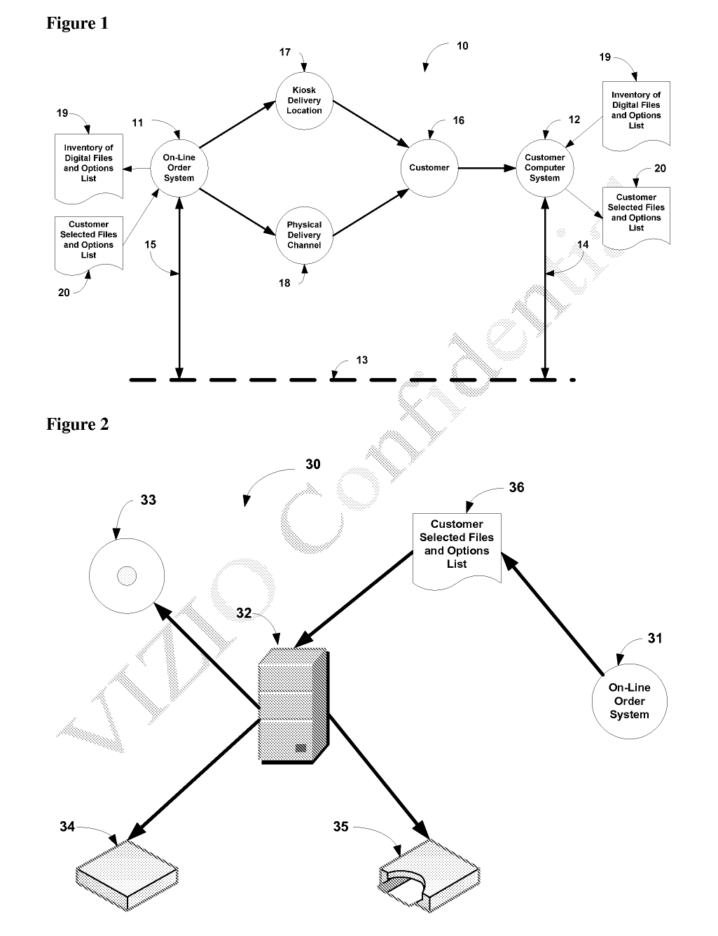

FIG. 1 illustrates a flow diagram 10 of an embodiment. In this closed loop system, Customer (16) uses Customer Computer System (12) connected to a network, e.g., the internet (13) through connection (14) to communicate with On-Line Order System (11) connected to the internet through connection (15). On-Line Order System (11) generates an Inventory of Digital Files and Options List (19) and transfers that list 19 to Customer Computer System (12) through the Internet (13) over internet connections (14) and (15). Customer (16) is allowed to make selections of digital files, media to transport said files, and payment options for rental or purchase of the digital files as well as the rental or purchase of the media if applicable. This is used to create Customer Selected Files and Options (20). Customer Computer System (12) transfers Customer Selected Files and Options (20) to On-Line Order System (11) through the Internet (13) and internet connections (14) and (15). On-line Order System (11) processes the customer selections and sends the selected digital files to Customer (16) through one of the delivery options selected by Customer (16) and bills Customer (16) by the payment options specified by Customer (16). If Customer (16) selected physical deliver of media, On-Line Order System (11) processes the selected digital files to write them on to the media selected by Customer (16).

In an embodiment, different forms of media can be specified by Customer (16). For example, customer 16 can specify the media to be written on a Flash Memory device; a rotating magnetic hard disk drive; or a write once piece of optical media such as CDC-R or DVD-R/+R media; Blu-Ray media, or HD DVD media. The information is written on to the media, and the specific piece of media is processed to be transferred to Customer (16) via a Physical Delivery Channel (18). Physical Delivery Channels (18) may be, but are not limited to: United States Postal Service; United Parcel Service; or FedEx.

Another embodiment allows the Customer (16) to select kiosk delivery. In this case, the On-Line Order System (11) bills Customer (16) according to the payment options specified by Customer (16) and notifies the closest or otherwise selected Kiosk Delivery Location (17) to Customer (16) of the customer's selections. When Customer (16) visits Kiosk Delivery Location (17), the kiosk system transfer the digital files selected by Customer (16) onto the media specified by Customer (16). In another embodiment, if Customer (16) selected electronic file transfer, then On-Line Order System (11) transfers to Customer Computer System (12), the digital files selected by Customer (16), over said internet connections.

In the embodiment, the digital files can be stored compressed, for example using MPEG4. Another embodiment can store the files in one of the formats defined by Adobe System for its Adobe Player, said algorithms more commonly known as SWF, a proprietary vector graphics file format produced by the Flash authoring software from Adobe Systems; Flash animation or Flash cartoon, a proprietary file format produced by the Flash animation software from Adobe systems and often distributed in the .swf file format; Shockwave Flash a proprietary file format produced by the authoring tool Macromedia Director from Adobe Systems and often distributed in the .dcr file format. The files can be encoded with the algorithms defined by Apple Inc. for its QuickTime Player, said algorithms more commonly known as: MOV, a proprietary file format functions as a multimedia container file that contains one or more encoded tracks, each of which stores a particular type of data: audio, video, effects, or text created by authoring software from Adobe Inc. Alternatively, it can be encoded using Microsoft Windows Media Player formats, e.g. WMV (*.wmv) files using Microsoft's ASF container format that contains data encoded using the Windows Media Video 9 codec or the codec referred to as the Society of Motion Picture and Television Engineers (SMPTE) 421M video codec created by authoring software from Microsoft. Another format that can be used is the RealNetworks, e.g. the RealVideo, a proprietary file format produced by the Flash authoring software from RealNetworks.

The files can be audio files, encoded with any of the audio codec algorithms defined by the Moving Picture Experts Group, Dolby Digital audio codec algorithms defined by Dolby Laboratories, Inc, Adaptive Transform Acoustic Coding (ATRAC) proprietary audio compression algorithms developed by Sony, Pulse-code modulation (“PCM”), Vorbis created by the Xiph.Org Foundation and generally used in conjunction with the Ogg container and then generally referred to as Ogg Vorbis.

When the files are written to media, they may be encrypted. The encryption may use Content Protection for Recordable Media and Pre-Recorded Media (CPRM/CPPM) which is a mechanism for controlling the copying, moving and deletion of digital media on a host device, such as a personal computer, or other digital player. AES as defined by the National Institute of Standards and Technology (NIST) as U.S. FIPS PUB 197 (FIPS 197) in Nov. 26, 2001 may be used. DES as defined by the National Institute of Standards and Technology (NIST) as U.S. FIPS PUB 46-3 (FIPS 46-3) in 1998 may be used. Public key cryptography, also known as asymmetric cryptography where said key used to encrypt said digital files on said media is the public key associated with said media, and where said key used to decrypt said digital files on said media is the private key associated with said media.

The files can be video game files, e.g. intended to be executed on an Xbox video game console platform, those intended to be executed on a Sony PlayStation video game console platform created by Sony, or those intended to be executed on Nintendo video game console platforms created by Nintendo. The files can have special attributes that allow them to be played on the console, which does not usually play copied disks.

The digital files can also be electronic books having displayable text and images.

FIG. 2 illustrates how the digital files are transferred to media (30). In an On-Line Order System (31) transfers Customer Selected Files and Options List (36) to Content Server (32). Content Server (32) transfers the selected files specified on Customer Selected Files and Options List (46) to one of three media. These possible media options are: Write Once Optical Media (33), Hard Disk Drive Media (34), and Memory Flash Card Media (35). Write Once Optical Media (33) may be, but is not limited to, CD/R media, Magneto-Optical media, or DVD-R/+R media; Blu-Ray media, or HD DVD media. Once the digital files have been transferred to the selected media that said media will be packaged and shipped to the customer. In an embodiment, the media will be inserted into the media drive device or connected to said Content Server (32) by a person; one piece of media at a time. In another embodiment, the media is inserted into said drive device or connected to said Content Server (32) by a robotic device. In this embodiment the media may, after having said files transferred to it, be removed and packaged by a person or by the same or a different robotic device prior to being shipped to said customer.

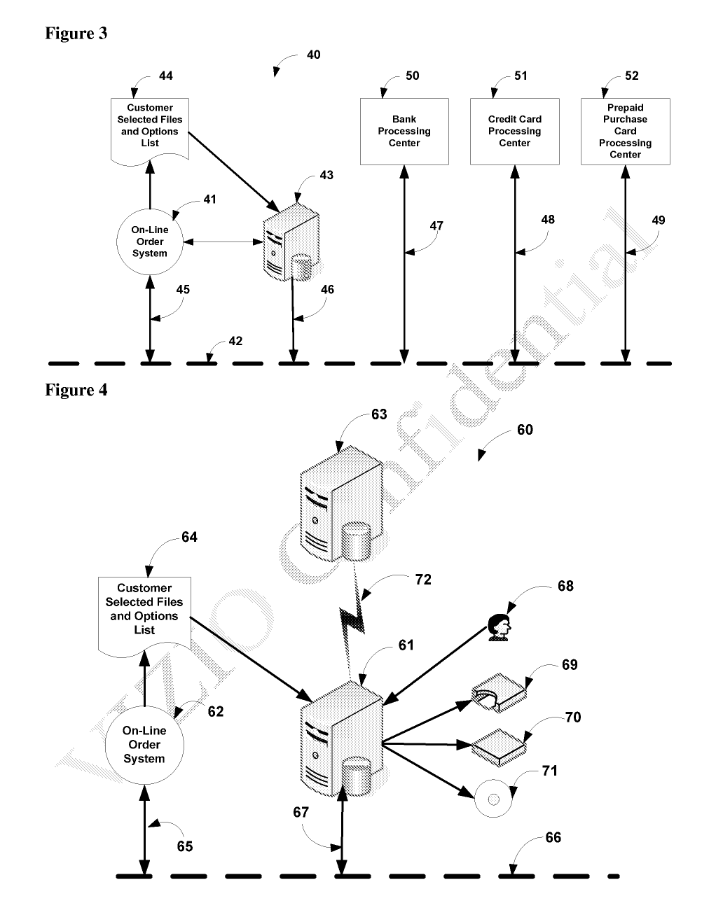

FIG. 3 illustrates the processing of customer billing. On-Line Order System (41) transfers Customer Selected Files and Options List (44) to Billing Server (43). Billing Server (43), depending on the payment option selected by the customer and specified in Customer Selected Files and Options List (46), initiates a secure connection with the associated processing center through Internet (42) and Internet Connection (46). The possible processing centers for any given billing transaction are: for bank debit cards the connection will be made to the associated Bank Processing Center (50) through Internet (42) and Internet Connection (47); for credit cards the connection will be made to the associated Credit Card Processing Center (51) through Internet (42) and Internet Connection (48); for prepaid purchasing cards the connection will be made to the associated Prepaid Purchase Card Processing Center (52) through Internet (42) and Internet Connection (49). The appropriate processing center processes the transaction and notifies the Billing Server (43) if the transaction was completed or denied. Billing Server (43) then notifies On-Line Order System (41) of the transaction status. If the transaction was completed, On-Line Order System (41) notifies the content server to transfer the customer selected digital files to the customer selected media. If the transaction is denied, On-Line Order System notifies the customer and requests that the customer enter another payment option or terminate the session.

FIG. 4 illustrates the Kiosk (60) processing. After customer (68) has completed the selection of digital files to rent or purchase and On-Line Order System (62) has processed the billing and Customer (68) indicated pickup of the media at a Kiosk (60), On-Line Order System (62) transfers or sends Customer Selected Files and Option List (64) to Kiosk Server (61) through Internet (66) and Internet Connections (65) and (67). Kiosk Sever (61) normally maintains a database of digital files and receives updates for digital files it does not currently have in its database from Master Content Server (63) over High-Speed Link (72), e.g. a T1 connection. When Kiosk Server (61) receives Customer Selected Files and Option List (64) it compares the digital files requested by the customer and downloads any missing files from Master Content Server (63). In one embodiment, Kiosk Server (61) has sufficient storage space to maintain several thousand of the most commonly requested digital files. Digital files rarely requested will be downloaded from Master Content Server (63) then removed as soon as the digital files are transferred to media for the customer or when space is needed.

In an embodiment, Customer (68) enters the Kiosk and enters identification information. Kiosk Server (63) then transfers the customer's requested digital files to the media requested by the customer. These possible media options are: Write Once Optical Media (71), Hard Disk Drive Media (70), and Memory Flash Card Media (69). Write Once Optical Media (71) may be, but is not limited to, CD/R media, Magneto-Optical media, or DVD-R/+R media; Blu-Ray media, or HD DVD media. Once the digital files have been transferred to the customer selected media, the media will be given to the customer. In another embodiment, Kiosk Server (63) transfers the customer selected digital files to the selected media as soon as Kiosk Server (63) receives Customer Selected Files and Options List (64) from On-Line Order System (62). In this embodiment, the media is held by the Kiosk personnel or robotics until Customer (68) enters the Kiosk and enters the identification information. At that time, the Kiosk personnel or robotics will provide the media to the customer. In another embodiment said media will be inserted into the media drive device or connected to Kiosk Server (61) by a person one piece of media at a time. In an embodiment, the media will be inserted into drive device or connected to Kiosk Server (61) by a robotic device. In this embodiment, the media may, after having said files transferred to it, be removed and given to Customer (68).

By allowing transfer of media in one of many different ways, this disclosure addresses the consumer issues of the traditional video rental store and addresses the issues of an operation such as NetFlix having to inventory hundreds of thousands of DVDs. The current disclosure also addresses the issue of music, game, and Electronic book rentals. The current disclosure offers the consumer an easy alternative to traditional methods of renting and buying movies, music, games, and electronic books. The disclosure also addresses the issue of the delivering high definition video content to the consumer. The major electronics manufacturers forced consumers into the middle of a video tape format war in prior years. These video tape formats were VHS and Beta Max. The consumer marketplace was fractured for years until consumers voted with their purchases and the predominate format of VHS won the war. Until that happened consumers were faced with the uncertainty of which tape player to purchase. Until VHS won the war the price of players and prerecorded media was artificially high. After VHS become the player and media of choice the price of equipment and media started dropping.

This also addresses the problems of multiple formats. When DVDs were first introduced to the marketplace, the cost of a DVD player was very high but consumers embraced the format because the quality of the content was superior to that offered by VHS tape. Consumers switched to DVDs and the cost of equipment dropped and the number of prerecorded titles increased and VHS tape was largely replaced by DVD disks. The consumer electronics companies are once again starting another format war with extended capacity DVDs being delivered in two new non-compatible formats (Blu-Ray and HD DVD). These formats are necessary because of the greater demands high definition video content makes on capacity. The cost of either a Blu-Ray or HD DVD player is quite high compared to that of a standard DVD player. The cost of prerecorded video content is also higher by at least twenty-five percent.

The present disclosure also addresses the format issue. This disclosure empowers the consumer with an alternative to yet another DVD format by allowing the consumer to purchase digital content on reusable media such as flash memory and rotating magnetic hard disk drives. The disclosure also addresses the issues of digital rights management and facilitates the consumer's ability to rent or buy content and in how that content is played.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other kinds of media may also be used for transferring the media information and other forms of information can be distributed using this system.

Also, the inventors intend that only those claims which use the words “means for” are intended to be interpreted under 35 USC 112, sixth paragraph. Moreover, no limitations from the specification are intended to be read into any claims, unless those limitations are expressly included in the claims.

The computers described herein may be any kind of computer, either general purpose, or some specific purpose computer such as a workstation. The computer may be a Pentium class computer, running Windows XP or Linux, or may be a Macintosh computer. The computer may also be a handheld computer, such as a PDA, cellphone, or laptop.

The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned.

What is claimed is:

1. A method comprising:
in a server computer, operating a program that allows remote users to initiate a session with the server computer, and to access a database to select one or more digital files from the database,
allowing a remote user to select delivery options for delivery of the digital files, where the delivery options include at least a first download option, and a second delivery of physical media option;
determining a cost for said files, and said delivery option, and providing information that allows the user to enter a payment option based on said determining;
responsive to said selecting a download option, transferring the digital file over a channel; and
responsive to said selecting a delivery of physical media option, transferring the digital file to the physical media.

2. A method as in claim 1, wherein said physical media is a writable disk.

3. A method as in claim 1, wherein said physical media is a flash drive.

4. A method as in claim 1, wherein said transferring occurs at a public kiosk, and said transferring to the physical media comprises transferring from the server to the kiosk, and requiring a user at the kiosk to identify themselves, followed by transferring to the physical media, in the kiosk.

5. A method as in claim 4, further requiring the user to provide the media at the kiosk, and where the kiosk writes to the provided media.

6. A method as in claim 1, wherein the transferring to physical media comprises writing the physical media, and the mailing the media to the user.

7. A method as in claim 1, wherein said transferring the fileon to the physical media comprises encrypting the file during said transferring.

8. A method as in claim 1, further comprising a third delivery option which includes a returnable medium, and wherein said determining the cost includes determining the cost for renting the returnable medium.

9. A method as in claim 1, further comprising a third delivery option which includes a purchasable medium, and said determining the cost includes determining the cost for purchasing the purchasable medium.

10. A method as in claim 9, wherein said purchasable medium is a hard drive.

11. A method as in claim 1, wherein said digital files include at least one of video files, audio files, playable game files, for files indicative of reading from the book.

12. A method comprising:
in a client computer, operating a program that allows remotely initiating a session with a server computer, to access a database that includes, and displays information indicative of plural digital files that can be checked out during said session;
in the client computer, allowing selection of one or more files based on the information;
allowing selection of delivery options for delivery of the digital files, where the delivery options include at least a first download option, and a second delivery of physical media option;
displaying a cost for said files and said delivery option;
accepting entry of a payment option for said cost; and
responsive to said selecting a download option, accepting the digital file over a channel.

13. A method as in claim 12, wherein said delivery option further comprises specifying a specific medium on which the files are to be written.

14. A method as in claim 13, wherein said medium is a writable disk.

15. A method as in claim 13, wherein said medium is a flash drive.

16. A method as in claim 12, wherein said transferring occurs at a public kiosk, and said transferring to the physical media comprises transferring from the kiosk, and requiring a user at the kiosk to identify themselves, followed by transferring to the physical media, at a location of the kiosk.

17. A method as in claim 16, further requiring the user to provide the media at the kiosk, and where the kiosk writes to the provided media.

18. A method as in claim 12, further comprising displaying a third delivery option which includes a returnable medium, and wherein said determining the cost includes determining the cost for renting the returnable medium.

19. A method as in claim 12, further comprising displaying a third delivery option which includes a purchasable medium, and said determining the cost includes determining the cost for purchasing the purchasable medium.

20. An apparatus comprising:
a computer, operating a program that allows users to initiate a session, and to access a database to select one or more digital files from the database,
a user interface producing part, allowing a user to select delivery options for delivery of the digital files, where the delivery options include at least a first download option, and a second delivery of physical media option, and which allows the user to enter a payment option based on said determining;
a connection for a media device to receive a transferred digital file.

21. An apparatus as in claim 20, wherein said apparatus is at a public kiosk, and digital file is transferred from a server to the kiosk, and said connection is part of the kiosk.
